(19) United States
(12) Patent Application Publication
(10) Pub. No.: US 2009/0286455 A1
(43) Pub. Date: Nov. 19, 2009

(54) METHOD FOR SIZING SINTERED METAL

(75) Inventor: Masato KANEKO, Ichihara-shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Idemitsu Kosan Co., Ltd., Chiyoda-ku (JP)

(21) Appl. No.: 12/509,072

(22) Filed: Jul. 24, 2009

Related U.S. Application Data
(63) Continuation of application No. 10/585,637, filed on Jul. 11, 2006, now abandoned.

(30) Foreign Application Priority Data
Mar. 31, 2004 (JP) 2004-102352

(51) Int. Cl. B25B 1/00

(52) U.S. Cl. 451/47; 451/54

(57) ABSTRACT

A method for producing a mechanical part comprising sizing a sintered metal unit with application of a lubricating oil composition containing (A) a lubricating base oil having a kinematic viscosity of 0.5 to 150 mm²/s at 40° C., and compounded therein (B) as an extreme-pressure and rust preventing agent, a high basic Ca sulfonate in an amount of 5 to 80% by mass, (C) as a rust preventing agent, a neutral Ba sulfonate and/or a fatty acid ester of a polyhydric alcohol in an amount of 0.5 to 30% by mass, (D) as a metal deactivator, a benzotriazole compound and/or thiadiazole compound in an amount of 0.005 to 10% by mass, and (E) an anti-oxidizing agent in an amount of 0.05 to 10% by mass, each based on a total amount of the composition.

### CROSS REFERENCE TO RELATED APPLICATIONS

This application is a continuation application of prior U.S. patent application Ser. No. 10/585,637, filed Jul. 11, 2006, the disclosure of which is incorporated herein by reference in its entirety. The parent application is the National Stage of PCT/JP2005/006041, filed Mar. 30, 2005, and claims priority to Japanese Application No. 2004-102352, filed Mar. 31, 2004, the disclosures of which are incorporated herein by reference in their entireties.

### BACKGROUND OF THE INVENTION

The present invention relates to a lubricating oil composition for sizing and, more specifically, to a lubricating oil composition for use in sizing a sintered metal, particularly a sintered metal for mechanical parts such as gears.

Mechanical parts such as gears of a sintered metal are generally produced through a compacting step, a sintering step, a sizing step and a grinding step. In the sizing step, a machining oil of a mineral oil has been hitherto used. The known machining oil has, however, a problem of rust generation after the grinding step. The lubricating oil for sizing has been found to have a great influence on the rust formation. Namely, because the conventionally used mineral oil-type machining oil does not have sufficient rust preventing properties, the sized frictional surface is susceptible to rust formation after the grinding step. There is also a room left for improvement in the conventional machining oil with respect to the machinability.

In this circumstance, there is a demand for a lubricating oil for sizing which exhibits excellent machinability and rust preventing properties. With regard to published documents, Patent Document 1 discloses the use of rapeseed oil. Patent Document 2 discloses an oil containing: a base oil composed of a synthetic ester and a fat and oil; a coloration preventing agent; and a stick preventing agent. There is a room left for the improvement in the known oils with respect to their performance.

[Patent Document 1] JP-A-H08-209370 (page 2)

[Patent Document 2] JP-A-2003-13084 (page 2)

### SUMMARY OF THE INVENTION

The present invention has been made in the above-described circumstance and an object of the present invention is to provide the provision of a lubricating oil composition for sizing which is excellent in machinability and in rust preventing properties.

The present inventors have made an intensive study and have found that the object can be effectively achieved by a composition containing a specific, low viscosity lubricating base oil and a specific, extreme-pressure and rust preventing agent compounded therein in a specific amount. The present invention has been completed on the basis of the above finding.

Thus, the gist of the present invention is as follows:

1. A lubricating oil composition for sizing, comprising (A) a lubricating base oil having a kinematic viscosity of 0.5 to 150 mm²/s at 40° C., and (B) as an extreme-pressure and rust preventing agent, a high basic Ca sulfonate compounded therein in an amount of 5 to 80% by mass based on a total amount of said composition.
2. A lubricating oil composition for sizing as defined in 1 above, further comprising (C) as a rust preventing agent, a neutral Ba sulfonate and/or a fatty acid ester of a polyhydric alcohol compounded therein in an amount of 0.5 to 30% by mass based on a total amount of said composition.
3. A lubricating oil composition for sizing as defined in 1 or 2 above, further comprising (D) as a metal deactivator, a benzotriazole compound and/or thiadiazole compound compounded therein in an amount of 0.005 to 10% by mass based on a total amount of said composition.

4. A lubricating oil composition for sizing as defined in any one of 1 through 3 above, further comprising (E) an anti-oxidizing agent compounded therein in an amount of 0.05 to 10% by mass based on a total amount of said composition.

### DETAILED DESCRIPTION OF THE PREFERRED EMBODIMENTS

According to the present invention a lubricating oil composition for sizing which exhibits excellent machinability and rust preventing properties may be provided.

In the lubricating oil composition for sizing according to the present invention, it is essential that a mineral oil and/or a synthetic oil having a kinematic viscosity in the range of 0.5 to 150 mm²/s at 40° C. be used as a base oil. A viscosity less than 0.5 mm²/s is disadvantageous because of a reduction of the strength of oil films and an increase of the loss by evaporation. A viscosity exceeding 150 mm²/s results in a poor separability of the oil and an increase of loss of the oil by being carried. Additionally, the oil becomes undesirably sticky. The kinematic viscosity is preferably 0.5 to 100 mm²/s, more preferably 0.5 to 60 mm²/s.

Various mineral oils may be usable. Examples of such mineral oils include distillate oils obtainable by atmospheric distillation of paraffin base crude oils, intermediate base crude oils or naphthene base crude oils, distillate oils obtainable by vacuum distillation of residual oils of the above atmospheric distillation, and refine oils obtainable by refining the above distillate oils in a conventional manner, such as solvent refined oils, hydrogenation refined oils, dewaxed oils and clay treated oils. Above all highly refined mineral oils are preferable from the standpoint of oxidization stability.

As the synthetic oil, there may be used, for example, a poly(α-olefin), an olefin copolymer (such as an ethylene-propylene copolymer), a branched polyolefin such as polybutene, polyisobutylene or polypropylene, a hydrogenated product of the above polymer, an alkylbenzene or an alkylnaphthalene. Above all, a poly(α-olefin) is preferable.

As the base oil in the present invention, the above-described mineral oils may be used singly or in combination of two or more thereof and the above-described synthetic oils may be used singly or in combination of two or more thereof. It is also possible to use one or more mineral oils in conjunction with one or more synthetic oils. The pour point which is an index of the characteristics at low temperatures is not specifically limited but is preferably −10° C. or lower.

In the lubricating oil composition for sizing according to the present invention, a high basic Ca sulfonate is used as an extreme-pressure and rust preventing agent, being a component (B).

The high basic Ca sulfonate is a Ca salt of a sulfonic acid. Examples of the sulfonic acid include aromatic petroleum sulfonic acids, alkylsulfonic acids, arylsulfonic acid and alkylarylsulfonic acid. Specific examples of the sulfonic acid include dodecylbenzenesulfonic acid, dilaurylcetylbenzenesulfonic acid, paraffin wax-substituted benzenesulfonic acid, polyolefin-substituted benzenesulfonic acid, polyisobutylene-substituted benzenesulfonic acid and naphthalenesulfonic acid. The total base value is preferably at least 50 mg KOH/g (JIS K2501; perchloric acid method), more preferably at least 200 mg KOH/g, still more preferably at least 400 mg KOH/g, from the standpoint of the amount to be added.

The above sulfonates may be used singly or in combination of two or more as the component (B). The amount of the component (B) is 5 to 80% by mass based on a total amount of the composition. An amount of the component (B) less than 5% by mass is insufficient to exhibit its effect. Too large an amount in excess of 80% by mass fails to exhibit any additional effect and, therefore, is uneconomical. Preferably, the amount is 5 to 50% by mass, more preferably 5 to 30% by mass.

In the lubricating oil composition for sizing according to the present invention, a neutral Ba sulfonate and/or a fatty acid ester of a polyhydric alcohol may be additionally used, if necessary, as a rust preventing agent, being a component (C).

The neutral Ba sulfonate is a Ba salt of a sulfonic acid and has a total base value of almost 0 mg KOH/g (JIS K2501; perchloric acid method). As the sulfonic acid, there may be mentioned the same sulfonic acids described for the component (B).

The fatty acid ester of a polyhydric alcohol may be a full ester or a partial ester. The polyhydric alcohol are preferably trihyric to hexahydric alcohols, such as glycerin, trimethylolethane, trimethylolpropane, erythritol, pentaerythritol, arabitol, sorbitol and sorbitan.

The fatty acid preferably has at least 12 carbon atoms, preferably 12 to 24 carbon atoms. The fatty acids having 12 to 24 carbon atoms may be linear or branched and may be saturated or unsaturated.

Specific examples of the linear saturated fatty acid include lauric acid, tridecylic acid, myristic acid, pentadecylic acid, palmitic acid, margaric acid, stearic acid, nonadecanoic acid, arachic acid, behenic acid and lignoceric acid. Specific examples of linear unsaturated fatty acid include linderic acid, 5-lauroleic acid, tsuzuic acid, myristoleic acid, palmitoleic acid, peteroselinic acid, oleic acid, elaidic acid, codoic acid, erucic acid and selacholeic acid

Specific examples of the branched saturated fatty acid include methylundecanoic acids, propylnonanoic acids, methyldodecanoic acids, propyldecanoic acids, methyltridecanoic acids, methyltetradecanoic acids, methylpentadecanoic acids, ethyltetradecanoic acids, methylhexadecanoic acids, propyltetradecanoic acids, ethylhexadecanoic acids, methylheptadecanoic acids, butyltetradecanoic acids, methyloctadecanoic acids, ethyloctadecanoic acids, methylnonadecanoic acids, ethyloctadecanoic acids, methyleicosanoic acids, propyloctadecanoic acids, butyloctadecanoic acids, methyldocosanoic acids, pentyloctadecanoic acids, methyltricosanoic acids, ethyldocosanoic acids, propylhexaeicosanoic acids, hexyloctadecanoic acids; 4,4-dimethyldecanoic acid; 2-ethyl-3-methylnonanoic acid; 2,2-dimethyl-4-ethyloctanoic acid; 2-propyl-3-methylnonanoic acid; 2,3-dimethyldodecanoic acid; 2-butyl-3-methylnonanoic acid; 3,7,11-trimethyldodecanoic acid; 4,4-dimethyltetradecanoic acid; 2-butyl-2-pentylheptanoic acid; 2,3-dimethyltetradecanoic acid; 4,8,12-trimethyltridecanoic acid; 14,14-dimethylpentadecanoic acid; 3-methyl-2-heptylnonanoic acid; 2,2-dipentylheptanoic acid; 2,2-dimethylhexadecanoic acid; 2-octyl-3-methylnonanoic acid; 2,3-dimethylheptadecanoic acid; 2,4-dimethyloctadecanoic acid; 2-butyl-2-heptylnonanoic acid; and 20,20-dimethylheneicosanoic acid.

Specific examples of branched unsaturated fatty acid include 5-methyl-2-undecenoic acid, 2-methyl-2-dodecenoic acid, 5-methyl-2-tridenenoic acid, 2-methyl-9-octadecenoic acid, 2-ethyl-9-octadecenoic acid, 2-propyl-9-octadecenoic acid, and 2-methyl-eicocenoic acid. Among the above fatty acids having 12 to 24 carbon atoms, stearic acid, oleic acid, and 16-methylheptadecanoic acid (isostearic acid) are preferable.

The above fatty acid esters of the component (C) may be used singly or in combination of two or more thereof. The amount of the component (C) is 0.5 to 30% by mass based on a total amount of the composition. An amount of the component (C) less than 0.5% by mass is insufficient to exhibit the rust preventing effect. Too large an amount in excess of 30% by mass fails to exhibit any additional effect and, therefore, is economically disadvantageous. Preferably, the amount is 0.5 to 20% by mass.

In the lubricating oil composition for sizing according to the present invention, a benzotriazole compound and/or thiadiazole compound may be additionally used, if necessary, as a metal deactivator, being a component (D).

The benzotriazole compound may be benzotriazole or an alkylbenzotriazole represented by the general formula (I) shown below, an N-(alkyl)alkylbenzotriazole represented by the general formula (II) shown below, or an N-(alkyl)aminoalkylbenzotriazole represented by the general formula (III) shown below:

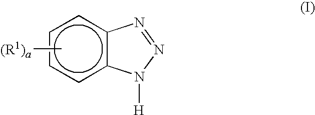

wherein R¹ represents an alkyl group having 1 to 4 carbon atoms and a is an integer of 0 to 4.

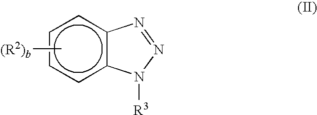

wherein R² and R³ are same or different and each represent an alkyl group having 1 to 4 carbon atoms and b is an integer of 0 to 4.

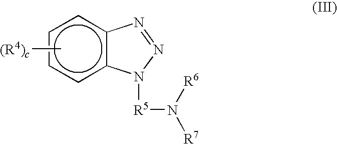

wherein R⁴ represents an alkyl group having 1 to 4 carbon atoms, R⁵ represents a methylene group, or an ethylene group, R⁶ and R⁷ are same or different and each represent a hydrogen atom or an alkyl group having 1 to 12 carbon atoms and c is an integer of 0 to 4.

The symbol R¹ in the above general formula (I) represents an alkyl group having 1 to 4 carbon atoms, preferably 1 or 2 carbon atoms. Specific examples of the alkyl group include a methyl group, an ethyl group, an n-propyl group, an isopropyl group, an n-butyl group, an isobutyl group, a sec-butyl group, and a tert-butyl group. The symbol a is an integer of 0 to 4, preferably 0 or 1.

The symbols R² and R³ in the above general formula (II) each represent an alkyl group having 1 to 4 carbon atoms, preferably 1 or 2 carbon atoms. Specific examples of the alkyl group are the same as those of R¹. The symbol b is an integer of 0 to 4, preferably 0 or 1.

The symbol R⁴ in the above general formula (III) represents an alkyl group having 1 to 4 carbon atoms, preferably 1 or 2 carbon atoms. Specific examples of the alkyl group are the same as those of R¹. The symbol R⁵ represents a methylene group or an ethylene group, preferably a methylene group. The symbols R⁶ and R⁷ each represent a hydrogen atom or an alkyl group having 1 to 12 carbon atoms, preferably 1 to 9 carbon atoms. Specific examples of the alkyl group include a methyl group, an ethyl group, an n-propyl group, an isopropyl group, an n-butyl group, an isobutyl group, a sec-butyl group, a tert-butyl group, various pentyl groups, various hexyl groups, various heptyl groups, various octyl groups, various nonyl groups, various decyl groups, various undecyl groups, and various dodecyl groups. The symbol c is an integer of 0 to 4, preferably 0 or 1.

Among the above-described benzotriazole compounds, benzotriazole, N-methylbenzotriazole, and N-dioctylaminomethyl-1,2,3-benzotriazole are preferable.

As the thiadiazole compound, there may be preferably used, for example, a 1,3,4-thiadiazole, a 1,2,4-thiadiazole, or a 1,4,5-thiadiazole represented by the following general formulas (IV):

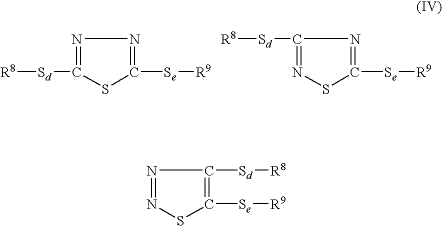

wherein R⁸ and R⁹ each represent a hydrogen atom or an alkyl group having 1 to 20 carbon atoms, and d and e are each an integer of 0 to 8.

Illustrative of suitable thiadiazole compounds are 2,5-bis(n-hexyldithio)-1,3,4-thiadiazole, 2,5-bis(n-octyldithio)-1,3,4-thiadiazole, 2,5-bis(n-nonyldithio)-1,3,4-thiadiazole, 2,5-bis(1,1,3,3-tetramethylbutyldithio)-1,3,4-thiadiazole, 3,5-bis(n-hexyldithio)-1,2,4-thiadiazole, 3,5-bis(n-octyldithio)-1,2,4-thiadiazole, 3,5-bis(n-nonyldithio)-1,2,4-thiadiazole, 3,5-bis(1,1,3,3-tetramethylbutyldithio)-1,2,4-thiadiazole, 4,5-bis(n-hexyldithio)-1,2,3-thiadiazole, 4,5-bis(n-octyldithio)-1,2,3-thiadiazole, 4,5-bis(n-nonyldithio)-1,2,3-thiadiazole, and 4,5-bis(1,1,3,3-tetramethylbutyldithio)-1,2,3-thiadiazole. Above all, 2,5-bis(n-octyldithio)-1,3,4-thiadiazole, and 2,5-bis(n-nonyldithio)-1,3,4-thiadiazole are preferable.

The above compounds of the component (D) may be used singly or in combination of two or more thereof. The amount of the component (D) is 0.005 to 10% by mass based on a total amount of the composition. An amount of the component (D) less than 0.005% by mass causes poor machinability. Too large an amount in excess of 10% by mass fails to exhibit any additional effect and, therefore, is uneconomical. Preferably, the amount is 0.03 to 5% by mass.

In the lubricating oil composition for sizing according to the present invention, an anti-oxidizing agent, being a component (D), may be additionally used, if necessary.

As the anti-oxidizing agent, there may be mentioned a phenol-type anti-oxidizing agent, an amine-type anti-oxidizing agent and a sulfur-type anti-oxidizing agent.

The phenol-type anti-oxidizing agent may be, for example, a monophenol-series such as 2,6-di-tert-butyl-4-methylphenol (hereinafter referred to as DBPC) or 2,6-di-tert-butyl-4-ethylphenol; a diphenol-series such as 4,4′-methylenebis(2,6-di-tert-butylphenol) or 2,2′-methylenebis(4-ethyl-6-tert-butylphenol); or a polymer-type phenol-series such as tetrakis[methylene-3-(3,5-di-tert-butyl-4-hydroxyphenyl)propionate]methane. The above phenol-type anti-oxidizing agents may be used singly or in combination of two or more thereof.

As the amine-type anti-oxidizing agent, there may be mentioned a monoalkyldiphenylamine-series such as monooctyldiphenylamine or monononyldipheylamine; a dialkyldiphenylamine-series such as 4,4′-dibutyldiphenylamine, 4,4′-dipentyldiphenylamine, 4,4′-dihexyldiphenylamine, 4,4′-diheptyldiphenylamine, 4,4′-dioctyldiphenylamine or 4,4′-dinonyldiphenylamine; a polyalkyldiphenylamine-series such as tetrabutyldiphenylamine, tetrahexyldiphenylamine, tetraoctyldiphenylamine or tetranonyldiphenylamine; or a naphthylamine-series such as α-naphthylamine, phenyl-α-naphthylamine, butylphenyl-α-naphthylamine, pentylphenyl-α-naphthyl amine, hexylphenyl-enaphthyl amine, heptylphenyl-α-naphthylamine, octylphenyl-α-naphthylamine, or nonylphenyl-α-naphthylamine. Above all, the dialkyldiphenylamine-series is preferable. The above amine-type anti-oxidizing agents may be used singly or in combination of two or more thereof.

As the sulfur-type anti-oxidizing agent, there may be mentioned phenothiazine, pentaerythritol-tetrakis-(3-laurylpropionate), bis(3,5-tert-butyl-4-hydroxybenzyl)sulfide, thiodiethylenebis(3-(3,5-di-tert-butyl-4-hydroxyphenyl)) propionate or 2,6-di-tert-butyl-4-(4,6-bis(octylthio)-1,3,5-triazine-2-methylamino)phenol. These sulfur-type anti-oxidizing agents may be used singly or in combination of two or more thereof.

The above various types of anti-oxidizing agents may be used in combination of two or more thereof.

The amount of the anti-oxidizing agent is in the range of 0.05 to 10% by mass based on a total amount of said composition, preferably 0.03 to 5% by mass.

In the lubricating oil composition for sizing according to the present invention, an additive or additives such as an extreme-pressure agent (phosphorus-series or sulfur-series), an antifoaming agent, a friction controlling agent, a cleaning dispersant, a viscosity index improver and a thickener may be compounded, if necessary, as long as the objects of the present invention are not adversely affected. It is preferred that the kinematic viscosity of the lubricating oil composition for sizing according to the present invention be finally adjusted in a range from 2 to 200 mm²/s at 40° C. for reasons of machinability and handling.

### EXAMPLES

The present invention will be further described with regard to examples but is not restricted to the examples in any way.

### Examples 1 to 10 and Comparative Examples 1 to 3

### (1) Preparation of Lubricating Oil Composition for Sizing

To the lubricating base oil shown in Table 1, components shown in Table 1 were compounded in amounts (% by mass) shown in Table 1 on the basis of the total amount of the composition, thereby to prepare lubricating oil compositions.

### (2) Evaluation Tests as Lubricating Oil for Sizing

The lubricating oil compositions for sizing thus prepared were subjected to evaluation tests in the manner shown below. The results are shown in Table 1.

### (a) Lubricity Test (JASO Pendulum Test)

In accordance with JASO M-314 6.13, the test was performed at room temperature to determine the coefficient of friction.

### (b) Anti-Rusting Test

The sizing oil was applied to a sintered metal. The metal was then allowed to stand for one day to separate the oil and, thereafter, subjected to a moistening test and an under-eaves exposure test.

Moistening test (49° C., 95% humidity): Test pieces were allowed to stand for 5 days. Thereafter the presence or absence of rust formation was judged.

Under-eaves exposure test: Test pieces were allowed to stand for 10 days. Thereafter the presence or absence of rust formation was judged.

TABLE 1

| | | | Ex. 1 | Ex. 2 | Ex. 3 | Ex. 4 | Ex. 5 | Ex. 6 |
|---|---|---|---|---|---|---|---|---|
| Amount | Base oil | A1 | 40 | | | | | |
| (% by mass) | | A2 | | 60 | 60 | | | |
| | | A3 | | | | 60 | 60 | 60 |
| | | A4 | | | | | | |
| | | A5 | | | | | | |
| | Extreme-pressure and anti- | B1 | 60 | 25 | 25 | 25 | 25 | 25 |
| | rust agent | B2 | | | | | | |
| | Rust preventing agent | C1 | | 15 | 10 | 10 | 10 | 10 |
| | | C2 | | | 5 | 3 | 3 | 3 |
| | Metal deactivator | D1 | | | | 2 | | |
| | | D2 | | | | | 2 | |
| | | D3 | | | | | | 2 |
| | Anti-oxidizing agent | E1 | | | | | | |
| | | E2 | | | | | | |
| Kinematic viscosity at 40° C. (mm²/s) | | | — | — | — | — | — | — |
| Lubricity | JASO pendulum test | Coefficient of | 0.115 | 0.116 | 0.118 | 0.102 | 0.104 | 0.103 |
| | | friction | | | | | | |
| Rust | Moistening test | Rust formation | none | none | None | none | none | none |
| preventive | Under-eaves exposure test | Rust formation | none | none | None | none | none | none |

| | | | | | | | Comp. | Comp. | Comp. |
|---|---|---|---|---|---|---|---|---|---|
| | | | Ex. 7 | Ex. 8 | Ex. 9 | Ex. 10 | Ex. 1 | Ex. 2 | Ex. 3 |
| Amount | Base oil | A1 | | 60 | | | 100 | | |
| (% by mass) | | A2 | | | | | | | |
| | | A3 | 60 | | | | | | |
| | | A4 | | | 60 | | | | |
| | | A5 | | | | 60 | | 100 | 40 |
| | Extreme-pressure and anti- | B1 | 25 | 25 | 25 | 25 | | | |
| | rust agent | B2 | | | | | | | 60 |
| | Rust preventing agent | C1 | 10 | 10 | 10 | 10 | | | |
| | | C2 | 3 | 3 | 3 | 3 | | | |
| | Metal deactivator | D1 | 1 | | | 1 | | | |
| | | D2 | | 1 | | | | | |
| | | D3 | | | 1 | | | | |
| | Anti-oxidizing agent | E1 | 1 | | 1 | 1 | | | |
| | | E2 | | 1 | | | | | |
| Kinematic viscosity at 40° C. (mm²/s) | | | 50.9 | 3.85 | 97.3 | 186.4 | 1.25 | 131 | 51.5 |
| Lubricity | JASO pendulum test | Coefficient of | 0.095 | 0.111 | 0.094 | 0.091 | 0.35 | 0.32 | 0.114 |
| | | friction | | | | | | | |
| Rust | Moistening test | Rust formation | none | none | none | none | form | form | form |
| preventive | Under-eaves exposure test | Rust formation | none | none | none | none | form | form | form |

Remarks:
Components of lubricating oil composition:
A1: Hydrogenated product of polyisobutene; Kinematic viscosity: 1.25 mm²/s at 40° C.
A2: Paraffin base mineral oil; Kinematic viscosity: 8.38 mm²/s at 40° C.; Sulfur content: 10 ppm or less
A3: Paraffin base mineral oil; Kinematic viscosity: 32.4 mm²/s at 40° C. Sulfur content: 10 ppm or less
A4: Naphthene base mineral oil; Kinematic viscosity: 56.8 mm²/s at 40° C. Sulfur content: 10 ppm or less
A5: Paraffin base mineral oil; Kinematic viscosity: 131 mm²/s at 40° C. Sulfur content: 950 ppm
B1: High basic Ca sulfonate; Total base value: 500 mgKOH/g
B2 (comparative): Soybean white squeeze oil; Kinematic viscosity: 30.5 mm²/s at 40° C.
C1: Neutral Ba Sulfonate
C2: Sorbitan monooleate
D1: N-Dioctylaminomethyl-1,2,3-benzotriazole
D2: Benzotriazole
D3: 2,5-bis(n-nonyldithio)-1,3,4-thiadiazole
E1: DBPC
E2: α-Naphthylamine

1. A method for producing a mechanical part, comprising:
sizing a sintered metal unit; and
grinding the sized metal unit;
wherein
a lubricating oil is applied to the sintered metal unit during sizing, and
the lubricating oil comprises:
(A) a lubricating base oil having a kinematic viscosity of 0.5 to 150 mm²/s at 40° C., and
(B) a high basic Ca sulfonate in an amount of 5 to 80% by mass based on a total amount of the lubricating oil.

2. The method for producing a mechanical part according to claim 1, wherein the lubricating oil applied during sizing further comprises at least one selected from the group consisting of a neutral Ba sulfonate, a fatty acid ester of a polyhydric alcohol and a mixture thereof in an amount of 0.5 to 30% by mass based on the total amount of the lubricating oil.

3. The method for producing a mechanical part according to claim 1, wherein the lubricating oil applied during sizing further comprises at least one selected from the group consisting of a benzotriazole compound, a thiadiazole compound and a mixture thereof in an amount of 0.005 to 10% by mass based on the total amount of the lubricating oil.

4. The method for producing a mechanical part according to claim 1, wherein the lubricating oil applied during sizing further comprises an anti-oxidizing agent in an amount of 0.05 to 10% by mass based on the total amount of the lubricating oil.

5. The method for producing a mechanical part according to claim 1, wherein the lubricating base oil is at least one selected from a group consisting of a mineral oil, a synthetic oil and a mixture thereof.

6. The method for producing a mechanical part according to claim 5, wherein the lubricating base oil is at least one mineral oil selected from the group consisting of a distillate oil obtained by atmospheric distillation of a paraffin base crude oil, an intermediate base crude oil or a naphthene base crude oil, a distillate oil obtained by vacuum distillation of a residual oil of an atmospheric distillation, and a refined oil selected from the group consisting of a solvent refined oil, a hydrogenation refined oil, a dewaxed oil and a clay treated oil.

7. The method for producing a mechanical part according to claim 5, wherein the lubricating base oil is at least one synthetic oil selected from the group consisting of a poly(α-olefin), an olefin copolymer, a branched polyolefin, polyisobutylene, polypropylene, a hydrogenated product thereof, an alkylbenzene and an alkylnaphthalene.

8. The method for producing a mechanical part according to claim 1, wherein a pour point of the lubricating base oil is −10° C. or lower.

9. The method for producing a mechanical part according to claim 1, wherein the high basic Ca sulfonate is at least one selected from the group consisting of an aromatic petroleum sulfonic acid, an alkylsulfonic acid, an arylsulfonic acid and an alkylarylsulfonic acid.

10. The method for producing a mechanical part according to claim 1, wherein the high basic Ca sulfonate is a Ca salt of at least one selected from the group of sulfonic acids consisting of dodecylbenzenesulfonic acid, dilaurylcetylbenzenesulfonic acid, a paraffin wax-substituted benzenesulfonic acid, a polyolefin-substituted benzenesulfonic acid, a polyisobutylene-substituted benzenesulfonic acid and naphthalenesulfonic acid.

11. The method for producing a mechanical part according to claim 1, wherein a total base value of the high basic Ca sulfonate is at least 50 mg KOH/g when measured by a perchloric acid method.

12. The method for producing a mechanical part according to claim 2, wherein the neutral Ba sulfonate is a Ba salt of at least one selected from the group of sulfonic acids consisting of dodecylbenzenesulfonic acid, dilaurylcetylbenzenesulfonic acid, a paraffin wax-substituted benzenesulfonic acid, a polyolefin-substituted benzenesulfonic acid, a polyisobutylene-substituted benzenesulfonic acid and naphthalenesulfonic acid.

13. The method for producing a mechanical part according to claim 2, wherein a total base value of the neutral Ba sulfonate is about 0 mg KOH/g when measured by a perchloric acid method.

14. The method for producing a mechanical part according to claim 2, wherein the polyhydric alcohol of the fatty acid ester of a polyhydric alcohol is at least one selected from the group consisting of glycerin, trimethylolethane, trimethylolpropane, erythritol, pentaerythritol, arabitol, sorbitol and sorbitan, and the fatty acid of the fatty acid ester of a polyhydric alcohol has 12 to 24 carbon atoms.

15. The method for producing a mechanical part according to claim 3, wherein the benzotriazole is at least one selected from the group consisting of benzotriazole, an alkylbenzotriazole represented by formula (I), an N-(alkyl)alkylbenzotriazole represented by formula (II), and an N-(alkyl)aminoalkylbenzotriazole represented by formula (III): 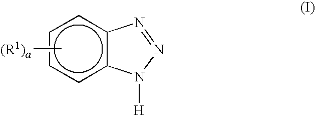
wherein R¹ represents an alkyl group having 1 to 4 carbon atoms and a is an integer of 0 to 4; 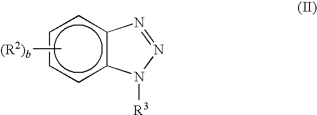
wherein R² and R³ are same or different and each represent an alkyl group having 1 to 4 carbon atoms and b is an integer of 0 to 4; 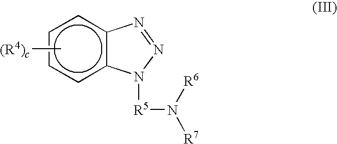
wherein R⁴ represents an alkyl group having 1 to 4 carbon atoms, R⁵ represents a methylene group, or an ethylene group, R⁶ and R⁷ are same or different and each represent a hydrogen atom or an alkyl group having 1 to 12 carbon atoms and c is an integer of 0 to 4.

16. The method for producing a mechanical part according to claim 3, wherein the benzotriazole is at least one selected from the group consisting of benzotriazole, N-methylbenzotriazole, and N-dioctylaminomethyl-1,2,3-benzotriazole.

17. The method for producing a mechanical part according to claim 3, wherein the thiadiazole is at least one selected from the group consisting of a 1,3,4-thiadiazole, a 1,2,4-thiadiazole, and a 1,4,5-thiadiazole represented by the following formulas (IV): 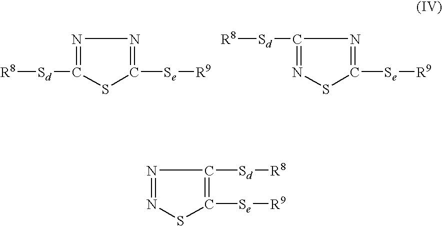
wherein R⁸ and R⁹ each represent a hydrogen atom or an alkyl group having 1 to 20 carbon atoms, and d and e are each an integer of 0 to 8.

18. The method for producing a mechanical part according to claim 4, wherein the anti-oxidizing agent is at least one selected from the group consisting of a phenolic anti-oxidizing agent, an amino anti-oxidizing agent and a sulfur anti-oxidizing agent.

19. The method for producing a mechanical part according to claim 1, wherein a kinematic viscosity of the lubricating oil is in the range from 2 to 200 mm²/s at 40° C.

20. The method for producing a mechanical part according to claim 1, wherein the lubricating oil applied during sizing further comprises at least one additive selected from the group of additives consisting of a phosphorous or sulfur containing extreme-pressure agent, an antifoaming agent, a friction controlling agent, a cleaning dispersant, a viscosity index improver and a thickener.
